(19) United States
(12) Patent Application Publication
(10) Pub. No.: US 2006/0038080 A1
(43) Pub. Date: Feb. 23, 2006

(54) Solar control method for spacecraft

(76) Inventor: Bernard Polle, Toulouse Cedex (FR)

Correspondence Address: STURM & FIX LLP, 206 SIXTH AVENUE, SUITE 1213, DES MOINES, IA, 50309-4076, US

(21) Appl. No.: 11/148,659

(22) Filed: Jun. 9, 2005

Related U.S. Application Data
(63) Continuation of application No. PCT/FR03/03567, filed on Dec. 2, 2003.

(30) Foreign Application Priority Data
Dec. 12, 2002 (FR) FR 02 15714

(51) Int. Cl. B64G 1/36

(52) U.S. Cl. 244/168

(57) ABSTRACT

The invention relates to a solar control method for spacecraft. The inventive method can be used for the three-dimensional control of a spacecraft (10) comprising a body (12) which is equipped with means of creating internal kinetic moments (14) and bearing two wings (16a, 16b) which are provided with solar panels. The aforementioned wings are disposed symmetrically on either side of the body of the craft (10) and can be oriented independently on the body (12) around a common axis (K). In addition, said wings are provided with elements (18a, 18b) which create a solar pressure force that is offset in relation to the axis of rotation (K) on one wing (16a, 16b) when said wing (16a, 16b) is mispointed around the aforementioned axis (K) in relation to the sun. In order to create a moment that can change the orientation of the craft (10) around a windmill axis (J) which is orthogonal to the mid-plane of the wings (16a, 16b), the wings (16a, 16b) are mispointed in an opposing member. Moreover, in order to create a moment that can change the orientation of the craft (10) around an axis of imbalance (I) which is located in the nominal plane of the wings (16a, 16b) and which is orthogonal to the axis of rotation (K) of the wings (16a, 16b) on the body (12), the wings (16a, 16b) are mispointed in the same direction.

The present invention relates to the solar control of a spacecraft and in particular of a satellite, by creating an external torque tending to rotate the satellite in an absolute reference frame, by giving the wings of the satellite pointing deviations in relation to their nominal orientation towards the sun. The wings are substantially symmetrical, provided with solar panels and can be oriented independently around a common axis.

Solar control methods are already known. In particular, document EP-A-0101333 describes and claims an attitude control method for a satellite placed in a geostationary orbit, designated GEO. The satellite is provided with two wings bearing solar panels, disposed symmetrically on either side of the body of the satellite and which can be oriented independently of each other around a north-south axis which constitutes the pitch axis of the body of the orbiting satellite. To augment the moments created by pointing deviations, each wing bears at least one oblique lateral fin.

A moment is created around a so-called axis of imbalance I which is located in the plane of the wings and orthogonal to the axis of rotation, by simultaneous mispointing, in the same direction and by the same amplitude, of both wings, from the nominal orientation. A so-called windmill moment is created around an axis J perpendicular to a mid-plane between the mispointed panels by mispointing the wings in opposing directions. However, it is not possible to create a torque around the common axis of rotation of the wings.

This control method, in a geostationary orbit where solar disturbances predominate, offers numerous advantages. It can be used to impart external torques compensation for the effect of the disturbances and to desaturate the internal kinetic moment transfer means (momentum wheels or gyrodynes) provided in the body of the satellite without consuming propellants. The presence of the fins makes it possible to achieve substantial torques despite the very low solar pressure value, which is of the order of 4.6×10⁻⁶ N/m².

However, it is not possible to create external torques around the axis of rotation of the wings, aligned with the pitch axis in geostationary orbit, since the axes I and J remain in one and the same plane in the orbital path. In a GEO orbit, it is therefore still necessary to use jets to obtain external moments.

Solar control is not currently used for satellites in low earth orbit (LEO) or middle earth orbit (MEO). There are various reasons for this exclusion. It is essential in particular to take into account the relatively high disturbing torques that affect the satellites. These are torques that are magnetic, aerodynamic, gravity gradient and solar in origin. The last of these predominates at the altitude of a geosynchronous orbit, which makes solar control attractive. In low earth orbit, the proximity of the planet is reflected in a strong field which makes magnetic control using magneto-couplers advantageous.

In current satellites in middle earth orbit, in particular at altitudes of around 20 000 km, magneto-couplers are also normally used, either directly for control, or to desaturate or unload the momentum wheels.

This solution is mainly used on ground positioning satellites (GPS satellites).

However, control by electromagnetic forces has drawbacks in the so-called middle earth orbits: since the magnetic field is weak, high currents are needed to create appreciable torques. The electromagnetic field generated by the couplers disturbs the clocks that need to be extremely accurate for this type of mission. At mid-altitudes, the magnetic field is relatively unstable and subject to magnetic storms.

In most cases, the middle earth orbits present a high inclination over the equator such that the elevation of the sun presents strong variations and can be very high at certain periods. These variations render the orientation of the axes I and J of the wings in relation to an inertial reference frame highly variable and can be used to create external moments throughout three-dimensional space.

The main object of the present invention is to provide a control method which can be used in particular to create the external moments required to complement the use of the kinetic moment transfer means borne by the body of a satellite or spacecraft and intended to orient the body of the satellite around the three axes of an inertial reference frame, in particular for satellites in middle earth orbit, such as the satellites used for navigation missions, requiring extremely stable and predictable orbits to achieve the necessary precision. A secondary object is to compensate for the disturbing torques that accumulate during the very long time intervals, often around a year, between in-situ maintenance procedures. Another object is to provide three-axis solar control on a spacecraft on an interplanetary path.

To this end, the invention proposes in particular an attitude control method for a spacecraft, and in particular a satellite placed in an orbit inclined over the equator, the body of the craft or satellite being provided with at least two wings disposed symmetrically on either side of the body of the craft or satellite and which can be oriented independently around a common axis.

According to a first aspect, the invention proposes a control method for a spacecraft comprising a body equipped with means of creating internal kinetic moments and bearing two wings which are provided with solar panels, disposed symmetrically on either side of the body of the craft, and which can be oriented independently on the body around a common axis and provided with elements which create a solar pressure force that is offset in relation to the axis of rotation on one wing when said wing is mispointed around said axis in relation to the sun, wherein:
(a) in order to create a moment tending to change the orientation of the craft around a windmill axis (J) which is orthogonal to the mid-plane of the wings, the wings are mispointed in an opposing manner, in order to create a moment tending to change the orientation of the craft around an axis of imbalance (I) which is located in the nominal plane of the wings and which is orthogonal to the axis of rotation of the wings on the body, the wings are mispointed in the same direction, characterized in that the attitude of the spacecraft is controlled to vary in time the orientation of the windmill and imbalance axes in order to temporarily create a moment around any direction in an inertial reference frame.

According to another aspect, the invention proposes a control method for a satellite placed in a non-geosynchronous orbit inclined over the equator, the satellite having a body equipped with means of creating internal kinetic moments and bearing two wings which are provided with solar panels, the wings being disposed symmetrically on either side of the body of the satellite, which can be oriented independently around a common axis and provided with elements such as fins which create a solar pressure force that is offset in relation to the axis of rotation on a wing when said wing is mispointed around said axis in relation to the sun, wherein:
the attitude of the orbiting satellite is controlled in such a way as to give both wings, outside periods in which desaturation torques are created, a nominal orientation which, at each point in the orbit, is such that an axis orthogonal to the plane of the wings is directed substantially towards the sun and such that an axis that is orthogonal both to the direction of the sun and to the axis of rotation of the wings sweeps a plane that is orthogonal to the direction to the sun, and
satellite control moments are created by giving both wings pointing deviations relative to their nominal orientation on the body of the satellite, in the same direction or in opposing directions, at positions in the orbit dependent on the orientation of the moment to be created.

Normally, the type of pointing used to implement the invention on a satellite will be “Solar Nadir pointing”. This pointing method allows a desaturation of the means of creating internal kinetic moments on the three axes whereas the control method in the case of a geostationary orbit would allow only an attitude control on the axes of the satellite orthogonal to the axis of rotation of the wings.

In the case of a spacecraft, during an interplanetary mission, the internal kinetic moment creation means can be used (rather than jets which offer poorer reliability) to create a slow spin or an orientation making it possible, by solar control, to unload the wheels or gyrodynes that were previously used to modify the pointing around the axis of rotation of the wings.

Although the invention can be implemented with wings with simple solar panels, it is advantageous to use a configuration of the type described in the aforementioned document EP-A-0101333 or another configuration giving a comparable effect.

The above features and others will become more apparent on reading the description that follows of a particular embodiment, given as a nonlimiting example.

The description refers to the appended drawings in which:

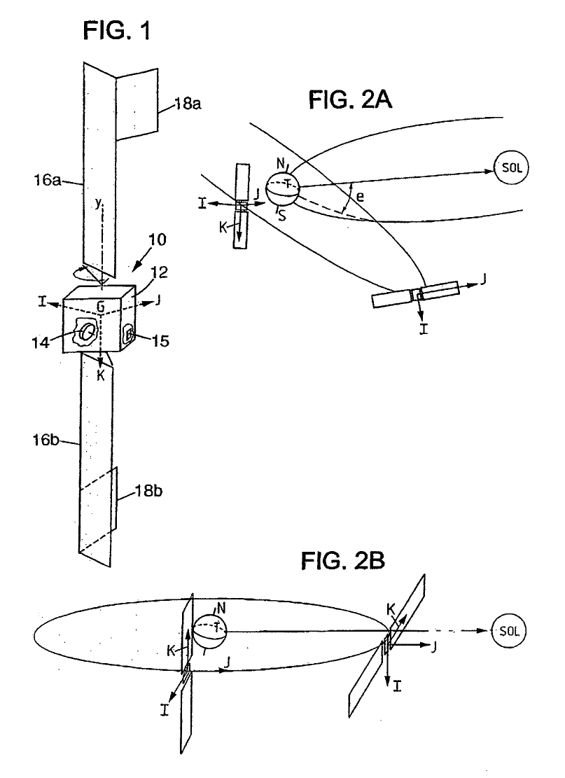

FIG. 1 is a schematic diagram showing the parameters involved in implementing the invention in its implementation on a satellite;

FIGS. 2A and 2B show the nominal “Solar Nadir” pointing of a satellite in a middle earth orbit, MEO, respectively for high and low elevations of the sun in relation to the orbital plane, each time for two positions of the satellite.

The satellite 10, diagrammatically represented in FIG. 1, has a body 12 which is equipped with two wings 16a and 16b which can rotate on the body around one and the same axis K. Motors, not shown, are used to rotate the wings 16a and 16b independently of each other around the axis K, for example in response to commands from a system incorporated in the satellite or originating from the ground. The body of the satellite further contains means providing a kinetic stabilization and control moment. These means can comprise in particular kinetic wheels of fixed axis 14 and controllable speed or gyroscopic actuators of which the wheel is borne by a joint that can be oriented. By transferring internal kinetic moments, the attitude of the body of the satellite can be maintained or controlled. It can be evaluated using sensors 15, for example a ground horizon sensor in the case of a satellite in middle earth orbit, when seeking to maintain an axis linked to the body oriented towards the earth (yaw axis).

In the advantageous embodiment shown in FIG. 1, on each wing 16a or 16b there is fixed a fin 18a or 18b, in an orientation in relation to the wing that is invariable. The two fins are symmetrical in relation to the center of the satellite when the wings are in the nominal position. Computation determines the effect of minor mispointings of the wings in relation to a nominal orientation towards the sun. The aforementioned document EP 010133 can be referred to on this subject.

The ability to create orientation torques by mispointing is not the same around all the axes passing through the center of gravity G of the satellite. The capacity to create an appreciable external torque immediately appears around two axes:
the axis J, that is often called the “windmill” axis, orthogonal to the mid-plane of the solar panels or the wings,
the axis I which is located in the mid-plane of the solar panels and orthogonal to the axis y of rotation of the solar panels, often called the axis of imbalance.

In geostationary satellites with solar control, the creation of torques by mispointing the two wings in the same direction or in opposing directions is already used to produce torques around the axes J and K. However, the spurious torques along the third axis, which constitute the yaw axis in a geostationary satellite, are accumulated by means presenting a kinetic moment (wheels or gyrodynes) and desaturation, when needed, is performed using the propulsion system. However, desaturation or simply unloading of the wheels using jets, which can be used moreover for any mission, disrupts the orbit of the satellite and consumes propellant. Furthermore, the propulsion systems are a long way from offering an absolute long-term reliability.

As stated above, the invention implies that, in the case of a satellite, the orbit is inclined over the equator or that the nominal pointing of the body of the satellite is sacrificed at certain periods of the mission.

In the case described here by way of example, the satellite is controlled according to a “solar nadir” pointing law and controlled mispointings, in the same direction or in opposing directions, of the wings in relation to the nominal “Solar Nadir” orientation are used for control purposes. In orbits that are greatly inclined to the ecliptic or to the equator, the angle of elevation of the sun relative to the orbital plane can, for example, assume the extreme positions shown in FIGS. 2A and 2B.

FIG. 2A shows the attitude taken by the satellite and by the two-position wings in orbit, when the solar elevation e is maximum (that is at the solstices). The axis J which is orthogonal to the plane of the wings is in all cases oriented towards the sun. However, the orientation of the axis K of rotation of the solar panels changes cyclically, in step with the orbital period. The axis of imbalance I sweeps the plane that is orthogonal to the direction of the sun.

These cyclic variations that occur in orbit can be used, at certain periods, to unload or desaturate the kinetic moment creation means and reorient the kinetic moment in such a way that a pointing in any direction of an inertial reference frame is possible. More specifically, solar control in such an orbit can be used to unload the means of creating internal kinetic moments (even directly modify the orientation of the satellite) around windmill and imbalance axes, respectively J and I, and furthermore to unload the means of creating kinetic moment around the axis K of rotation of the wings.

FIG. 2B, which shows successive orientations assumed by the satellite in its orbit when the elevation of the sun is zero (at the equinoxes), shows that the same possibility is still available. In all cases, the “active” axes I and J sweep the 3D space.

1. A control method for a spacecraft comprising a body equipped with means of creating internal kinetic moments and bearing two wings provided with solar panels, disposed symmetrically on either side of said body of said craft, and which can be oriented independently on said body around a common axis and provided with elements which create a solar pressure force offset in relation to said axis of rotation on one wing when said wing is mispointed around said axis in relation to the sun, wherein:
(a) in order to create a moment tending to change the orientation of said craft around a windmill axis which is orthogonal to a mid-plane of said wings, said wings are mispointed in an opposing manner,
(b) in order to create a moment tending to change the orientation of said craft around an axis of imbalance which is located in a nominal plane of said wings and which is orthogonal to said axis of rotation of said wings on said body, said wings are mispointed in the same direction,
(c) wherein the attitude of the spacecraft is controlled to vary in time the orientation of the windmill and imbalance axes in order to temporarily create a moment around any direction in an inertial reference frame.

2. The method as claimed in claim 1, wherein step (c) is performed by placing said vehicle in an orbit such that a common plane of said windmill and imbalance axes changes in said inertial reference frame along the orbital path.

3. The method as claimed in claim 2, wherein said craft is placed in an MEO orbit.

4. The method as claimed in claim 1, wherein, on a craft on an interplanetary mission, said step (c) is performed by orienting said wings towards the sun and by imparting upon said vehicle a slow spin around the direction of the sun.

5. The method as claimed in claim 1, wherein said axis of said wings is kept substantially orthogonal to the direction of the sun.

6. Control method for a satellite placed in a non-geosynchronous orbit inclined over the equator, the satellite having a body equipped with means of creating internal kinetic moments and bearing two wings which are provided with solar panels, disposed symmetrically on either side of said body of said satellite, which can be oriented independently around a common axis and provided with elements which create a solar pressure force that is offset in relation to said axis of rotation on a wing when said wing is mispointed around said axis in relation to the sun, wherein:
the attitude of said satellite when orbiting is controlled in such a way as to give both wings, outside periods in which desaturation torques are created, a nominal orientation which, at each point in the orbit, is such that an axis orthogonal to a plane of said wings is directed substantially towards the sun and such that an axis that is orthogonal both to the direction of the sun and to said axis of rotation of said wings sweeps a plane that is orthogonal to the direction to the sun, and
satellite control moments are created by giving both wings pointing deviations relative to a nominal orientation of said wings on said body of said satellite, in the same direction or in opposing directions, at positions in the orbit dependent on the orientation of the moment to be created.

7. The method as claimed in claim 1 or claim 6, wherein each of said wings is provided with at least one oblique lateral fin constituting said element which creates the solar pressure force offset in relation to said axis of rotation of said wing.
